(19) United States
(12) Patent Application Publication
(10) Pub. No.: US 2026/0214337 A1
(43) Pub. Date: Jul. 23, 2026

(54) SENSOR DRIVING DEVICE AND LENS MODULE

(71) Applicant: AAC Microtech (Changzhou) Co., Ltd., Changzhou City (CN)

(72) Inventors: Zhang Ren, Changzhou (CN); Wei Song, Changzhou (CN); Ronglin Linghu, Changzhou (CN); Tong Zhang, Changzhou (CN)

(21) Appl. No.: 19/333,419

(22) Filed: Sep. 19, 2025

Related U.S. Application Data
(63) Continuation of application No. PCT/CN2025/073516, filed on Jan. 21, 2025.

(51) Int. Cl. H04N 23/68; H04N 23/51; H04N 23/54

(52) U.S. Cl. CPC H04N 23/687; H04N 23/51; H04N 23/54

(57) ABSTRACT

A sensor driving device and a lens module are provided. The sensor driving device includes a housing, a sensor assembly, a driving assembly, and an elastic support component. The housing includes a bottom plate and an upper cover, the upper cover covers the bottom plate to define an accommodating space therebetween, the upper cover includes a light-transmitting hole. The sensor assembly includes a circuit board, a sensor, and a driving assembly. The driving assembly includes at least one coil holder, a magnetic circuit system, and a driving coil. The lens is partially inserted into the accommodating portion of the housing, the driving assembly, disposed between an outer wall of the lens and an inner wall of the housing, effectively utilizes an internal space of the housing, thereby avoiding enlargement of a screen opening of the lens, so as to effectively increase a screen-to-body ratio.

### CROSS-REFERENCE TO RELATED APPLICATIONS

This application is a continuation of International Application No. PCT/CN2025/073516, January 21, 2025, the entire contents of which are incorporated herein by reference.

### TECHNICAL FIELD

The present disclosure relates to the field of imaging devices, and in particular to a sensor driving device and a lens module.

### BACKGROUND

Current cameras used in augmented reality (AR) glasses are constrained by size and weight limitations, adopting a fixed-focus design without optical image stabilization (OIS). Therefore, a compact OIS design is essential.

In conventional OIS solutions involving lens movement, a screen opening must be enlarged, adversely affecting a screen-to-body ratio. Additionally, such designs require reserved space within a housing body of a driving device to accommodate lens movement, which hinders device miniaturization.

Consequently, resolving these technical challenges has become an urgent issue to be addressed by those who skilled in the art.

### SUMMARY

Embodiments of the present disclosure aim to solve at least one technical problem in the related art by providing a sensor driving device and a lens module.

In a first aspect, the embodiments of the present disclosure provide the sensor driving device, including a housing, a sensor assembly, a driving assembly, and an elastic support component. The housing includes a bottom plate and an upper cover, the upper cover covers the bottom plate to define an accommodating space therebetween, the upper cover includes a light-transmitting hole, the light-transmitting hole communicates the accommodating space and an external environment and is configured to communicate with a lens. The sensor assembly is disposed in the accommodating space, the sensor assembly includes a circuit board and a sensor, the sensor is disposed at one side of the circuit board close to the light-transmitting hole and is electrically connected to the circuit board. The driving assembly is disposed in the accommodating space, the driving assembly includes at least one coil holder, a magnetic circuit system, and a driving coil, the at least one coil holder is fixed to the one side of the circuit board close to the light-transmitting hole, the magnetic circuit system is fixed to an inner side of the upper cover, and the driving coil is fixed to an outer side of the at least one coil holder. The elastic support component is disposed in the accommodating space, the elastic support component is connected between the circuit board and the bottom plate, the elastic support component includes a first connecting portion, at least one second connecting portion, and at least one elastic arm, the first connecting portion is fixed to the bottom plate, the at least one second connecting portion is fixed to the circuit board, and the at least one elastic arm is configured to connect the first connecting portion and the at least one second connecting portion, the elastic support component is configured to suspend the sensor assembly in the accommodating space. The driving coil is disposed opposite to the magnetic circuit system, the driving coil and the magnetic circuit system cooperate to drive the sensor assembly to move along an optical axis of the lens.

As an improvement, the driving coil includes an upper coil portion and a lower coil portion, the upper coil portion is disposed close to the light-transmitting hole, and the lower coil portion is disposed close to the circuit board.

As an improvement, the magnetic circuit system includes a first magnet assembly and a second magnet assembly, the first magnet assembly and the second magnet assembly are respectively fixed to two opposite side walls of the upper cover. The first magnet assembly includes a first magnet and a second magnet, the first magnet and the second magnet are stacked along a direction parallel to the optical axis of the lens, and a magnetization direction of the first magnet is opposite to a magnetization direction of the second magnet. The second magnet assembly includes a third magnet and a fourth magnet, the third magnet and the fourth magnet are stacked along the direction parallel to the optical axis of the lens, and a magnetization direction of the third magnet is opposite to a magnetization direction of the fourth magnet. The upper coil portion is disposed opposite to the first magnet and the third magnet. The lower coil portion is disposed opposite to the second magnet and the fourth magnet.

As an improvement, the first magnet and the second magnet are integrally formed using a quadrupole magnetization process. The third magnet and the fourth magnet are integrally formed using the quadrupole magnetization process.

As an improvement, the magnetic circuit system includes the first magnet assembly and the second magnet assembly, the first magnet assembly and the second magnet assembly are respectively fixed to the two opposite side walls of the upper cover. Both the first magnet assembly and the second magnet assembly are integrally formed using a Halbach array process.

As an improvement, the at least one coil holder includes an annular mounting groove at one side thereof facing the magnetic circuit system, and the driving coil is annularly disposed in the annular mounting groove.

As an improvement, the at least one elastic arm includes a first force arm, a second force arm, and a third force arm. The first force arm is connected to the first connecting portion, the second force arm is bent and extend from the first force arm, the third force arm extends from one end of the second force arm away from the first force arm, and the third force arm is connected to the at least one second connecting portion. The first force arm is disposed opposite to the third force arm.

As an improvement, the elastic support component includes a plurality of elastic arms, the plurality of the elastic arms are rotationally symmetric about a center of the elastic support component.

As an improvement, the first connecting portion is frame-shaped. The at least one elastic arm and the at least one second connecting portion are disposed an outer peripheral side of the first connecting portion, and the at least one elastic arm is connected to an outer frame edge of the first connecting portion.

As an improvement, the bottom plate includes at least one clearance portion, the at least one clearance portion is configured to provide clearance for the at least one elastic arm.

As an improvement, two second connecting portions are provided and spaced apart from each other, each of the two second connecting portions is fixedly connected to the circuit board, two elastic arms are provided, the two second connecting portions are respectively connected to the two elastic arms, and third force arms of the two elastic arms extend in opposite directions.

As an improvement, the first connecting portion is frame-shaped. The at least one elastic arm and the at least one second connecting portion are disposed on an inner peripheral side of the first connecting portion, and the at least one elastic arm is connected to an inner frame edge of the first connecting portion.

As an improvement, four second connecting portions are provided, and the four second connecting portions are circumferentially spaced along the inner peripheral side of the first connecting portion. each of the four second connecting portions is fixedly connected to the circuit board, four elastic arms are provided, and the four second connecting portions are respectively connected to the four elastic arms.

As an improvement, at least one connecting post is disposed on the bottom plate, and a connecting protrusion extends from the at least one coil holder toward the circuit board. The at least one connecting post and the connecting protrusion of the at least one coil holder are connected through an elastic component.

In a second aspect, the embodiments of the present disclosure provide the lens module, including the sensor driving device as foregoing, the sensor assembly, and the lens. The sensor assembly is disposed in the housing and connected to the elastic support component. The lens is inserted into the light-transmitting hole on the upper cover of the housing to suspend in the accommodating space.

As an improvement, the lens includes a lens barrel and a lens assembly. The lens barrel includes an accommodating portion and a suspension structure, and the accommodating portion is configured to accommodate the lens assembly. The lens barrel is inserted into the light-transmitting hole on the upper cover of the housing through the suspension structure.

Beneficial effects of the present disclosure are as follows.

In a fixed-focus optical image stabilization (OIS) design of the present disclosure, movement of the sensor assembly eliminates the need to provide additional movement space for the lens assembly. Furthermore, the lens is partially inserted into the accommodating portion of the housing, thereby reducing an overall structural dimension of the lens module. The driving assembly, disposed between an outer wall of the lens and an inner wall of the housing, effectively utilizes an internal space of the housing, thereby avoiding enlargement of a screen opening of the lens, so as to effectively increase a screen-to-body ratio. Additionally, compared to conventional lens movement solutions, the sensor assembly in the present disclosure directly moves along a direction of the optical axis of the lens, so as to enable precise focus adjustment along the optical axis of the lens, achieving a wider field of view (FOV) under identical screen opening dimensions.

### BRIEF DESCRIPTION OF DRAWINGS

FIG. 1 is a structural schematic diagram of a lens module according to one embodiment of the present disclosure.

FIG. 2 is a cross-sectional schematic diagram taken along the line A-A shown in the lens module of FIG. 1, in which a positional relationship between a sensor driving device, a sensor assembly, and a lens is illustrated.

FIG. 3 is a partial enlarged structural schematic diagram of the sensor driving device shown in FIG. 2.

FIG. 4 is an exploded three-dimensional schematic diagram of the lens module shown in FIG. 1.

FIG. 5 is a structural schematic diagram of a bottom plate, an elastic support component, and a driving assembly according to one embodiment of the present disclosure.

FIG. 6 is a partial enlarged schematic diagram of portion A shown in FIG. 5.

FIG. 7 is a partial enlarged schematic diagram of portion B shown in FIG. 5.

FIG. 8 is an exploded three-dimensional schematic diagram of the driving assembly according to one embodiment of the present disclosure.

FIG. 9 is a structural schematic diagram of the elastic support component according to one embodiment of the present disclosure.

FIG. 10 is a partial enlarged schematic diagram of the elastic support component shown in FIG. 9.

FIG. 11 is a structural schematic diagram of the elastic support component according to another embodiment of the present disclosure.

FIG. 12 is a cross-sectional schematic diagram taken along the line A-A shown in the lens module of FIG. 1, in which the positional relationship between the sensor driving device, the sensor assembly, and the lens according to another embodiment of the present disclosure is illustrated.

FIG. 13 is a partial enlarged schematic diagram of the lens module shown in FIG. 12.

FIG. 14 is a structural schematic diagram of the elastic support component according to another embodiment of the present disclosure.

FIG. 15 is a partial enlarged schematic diagram of the elastic support component shown in FIG. 14.

FIG. 16 is a structural schematic diagram of the elastic support component according to another embodiment of the present disclosure.

FIG. 17 is a cross-sectional schematic diagram of a magnetic circuit system according to one embodiment of the present disclosure, in which a first magnet, a second magnet, a third magnet, and a fourth magnet are integrally formed using a quadrupole magnetization process, magnetization directions of the first magnet, the second magnet, the third magnet, and the fourth magnet are schematically indicated by arrows, and each of the arrows is defined as a direction from an S pole to an N pole.

FIG. 18 is a structural schematic diagram of an elastic component according to one embodiment of the present disclosure.

FIG. 19 is a cross-sectional schematic diagram of the magnetic circuit system according to one embodiment of the present disclosure, in which a first magnet assembly and a second magnet assembly are integrally formed using a Halbach array process, the magnetization directions of the first magnet, the second magnet, the third magnet, and the fourth magnet are schematically indicated by arrows, and each of the arrows is defined as the direction from the S pole to the N pole

FIG. 20 is an exploded three-dimensional schematic diagram of the sensor assembly shown in FIG. 4.

Reference numerals in the drawings: 100-lens module; 10-sensor driving device; 20-sensor assembly; 30-lens; 11-housing; 12-elastic support component; 13-driving assembly; 14-connecting post; 15-connecting protrusion; 16-elastic component; 111-accommodating space; 112-bottom plate; 113-light-transmitting hole; 114-bottom through hole; 115-upper cover; 121-first connecting portion; 122-second connecting portion; 123-elastic arm; 1121-clearance portion; 1231-first force arm; 1232-second force arm; 1233-third force arm; 131-magnetic circuit system; 132-driving coil; 133-coil holder; 1312-first magnet assembly; 1313-second magnet assembly; 13121-first magnet; 13122-second magnet; 1321-upper coil portion; 1322-lower coil portion; 13131-third magnet; 13132-fourth magnet; 1331-mounting groove; 1332-positioning protrusion; 21-circuit board; 22-sensor; 23-sensor holder; 24-filter; 31-optical axis; 32-lens barrel; 33-lens assembly; 231-mounting cavity; 321-accommodating portion; 322-suspension structure; 161-first connecting component; 162-second connecting component; 163-bent elastic component.

### DETAILED DESCRIPTION OF EMBODIMENTS

To enable those who skilled in the art to better understand technical solutions of the present disclosure, the following detailed description is provided in conjunction with accompanying drawings and specific embodiments.

The following description, together with the accompanying drawings, is intended to illustrate implementation modes of the present disclosure in an exemplary manner. However, these descriptions and drawings are not to be construed as limiting a scope of the present disclosure. That is, the present disclosure is not limited to the embodiments specifically described herein. In the description of the present disclosure, it should be noted that, unless otherwise specified, a term "a plurality" means two or more. Directional terms, such as "upper", "lower", "left", "right", "inner", "outer", etc., are solely used for purpose of facilitating the description and simplifying the explanation of the present disclosure. These terms do not indicate or imply that referenced devices or components must be arranged in a specific orientation or configuration. Therefore, these terms should not be interpreted as limiting a scope of the present disclosure. Furthermore, terms "first", "second", etc. are solely used for a purpose of identification and description, and should not be interpreted as indicating or implying relative importance. A term "perpendicular" is not intended to mean strictly perpendicular, but rather within an allowable error range. Similarly, a term "parallel" is not intended to mean strictly parallel, but rather within an allowable error range.

Furthermore, in the description of the present disclosure, unless otherwise explicitly stated or defined, terms "mounted", "connected to", "connected with" etc. are to be interpreted in a broad sense. For example, such terms may refer to a fixed connection, a detachable connection, or an integral connection, and may also mean a direct connection or an indirect connection through one or more intermediate elements. For those who skilled in the art, specific meaning of these terms in the present disclosure may be understood according to a particular context and implementation.

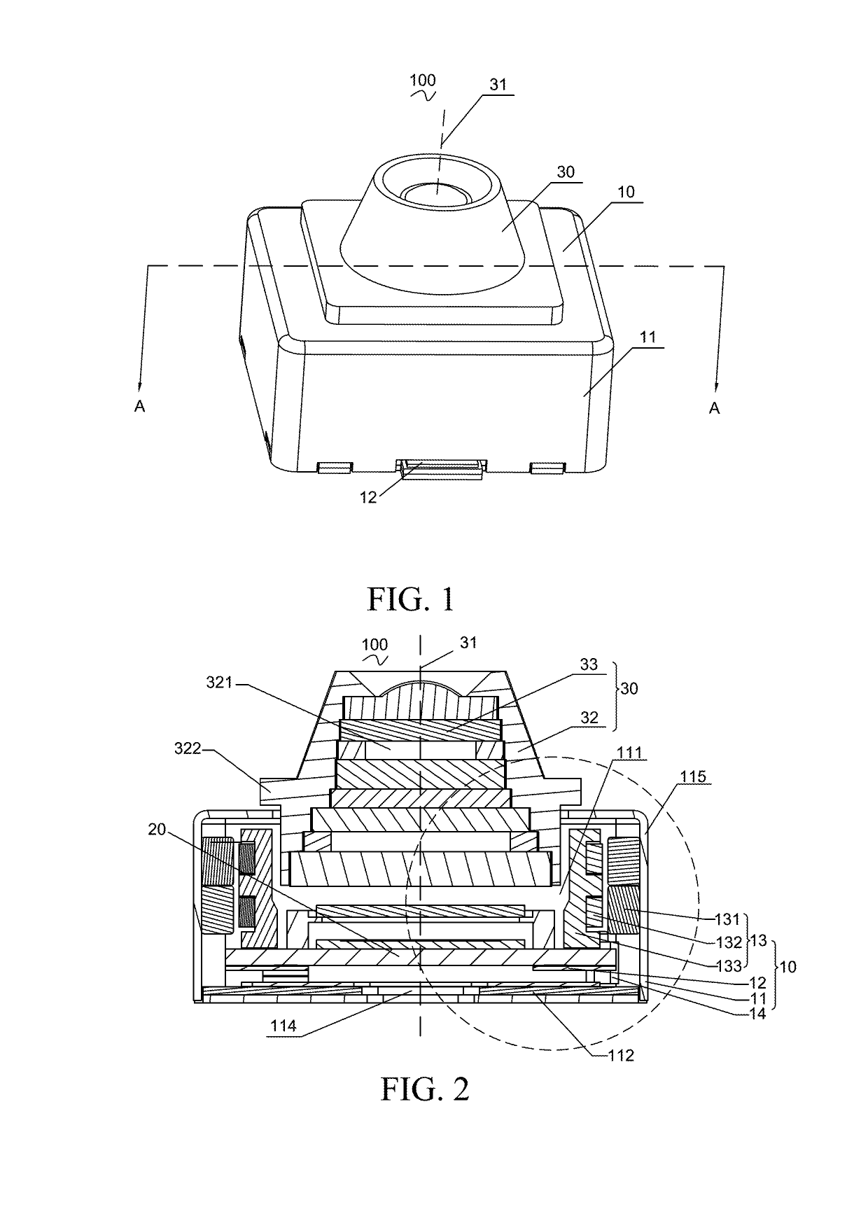

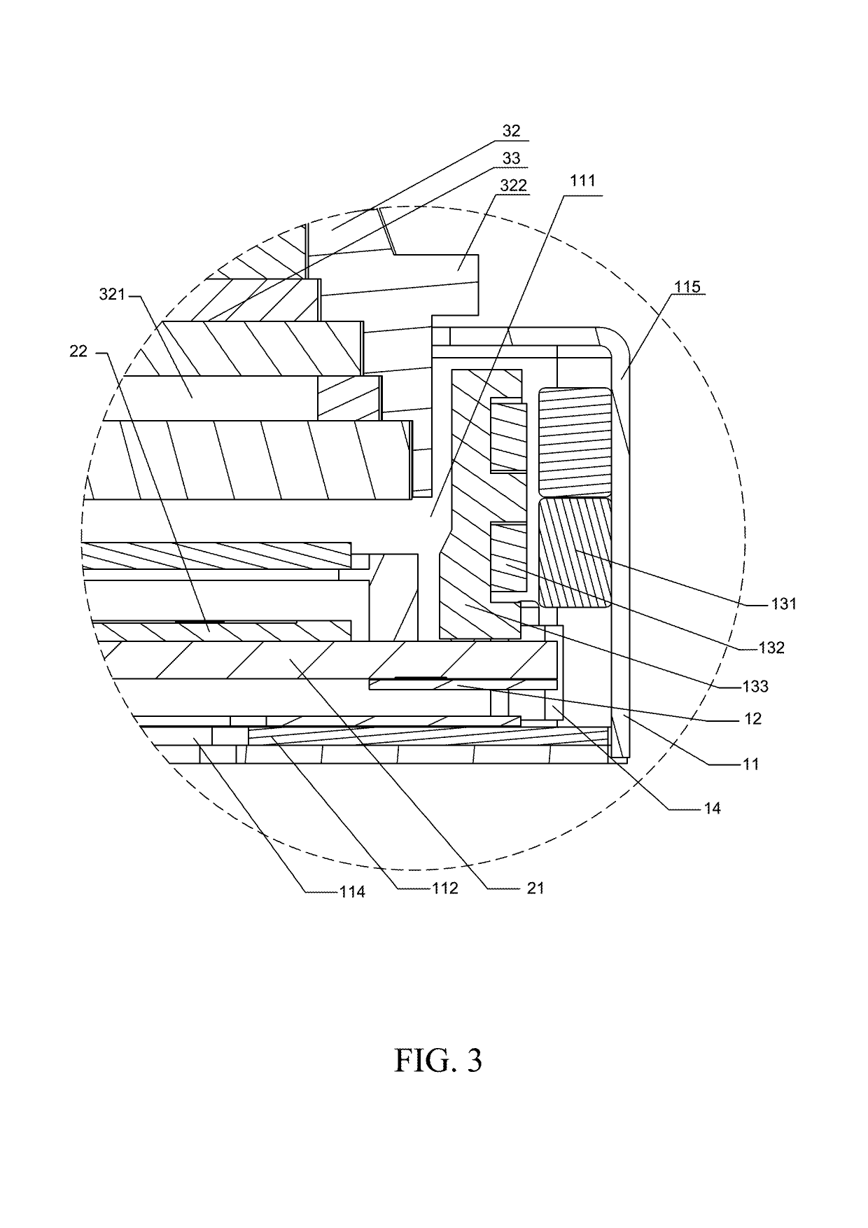

As shown in FIGS. 1-4, a sensor driving device 10 is provided, including a housing 11, a sensor assembly 20, an elastic support component 12, and a driving assembly 13. The housing 11 includes a bottom plate 112 and an upper cover 115, the upper cover 115 covers the bottom plate 112 to define an accommodating space 111 therebetween, the upper cover 115 includes a light-transmitting hole 113, the light-transmitting hole 113 communicates the accommodating space 111 and an external environment and is configured to communicate with a lens 30.

The sensor assembly 20 is disposed in the accommodating space 111, the sensor assembly 20 includes a circuit board 21 and a sensor 22, the sensor 22 is disposed at one side of the circuit board 21 close to the light-transmitting hole 113 and is electrically connected to the circuit board 21.

The driving assembly 13 is disposed in the accommodating space 111, the driving assembly 13 includes at least one coil holder 133, a magnetic circuit system 131, and a driving coil 132, the at least one coil holder 133 is fixed to the one side of the circuit board 21 close to the light-transmitting hole 113, the magnetic circuit system 131 is fixed to an inner side of the upper cover 115, and the driving coil 132 is fixed to an outer side of the at least one coil holder 133.

The elastic support component 12 is disposed in the accommodating space 111, the elastic support component 12 is connected between the circuit board 21 and the bottom plate 112, the elastic support component 12 includes a first connecting portion 121, at least one second connecting portion 122, and at least one elastic arm 123, the first connecting portion 121 is fixed to the bottom plate 112, the at least one second connecting portion 122 is fixed to the circuit board 21, and the at least one elastic arm 123 is configured to connect the first connecting portion 121 and the at least one second connecting portion 122, the elastic support component 12 is configured to suspend the sensor assembly 20 in the accommodating space 111.

The driving coil 132 is disposed opposite to the magnetic circuit system 131, the driving coil 132 and the magnetic circuit system 131 cooperate to drive the sensor assembly 20 to move along an optical axis 31 of the lens 30.

In a fixed-focus optical image stabilization (OIS) design of the present disclosure, movement of the sensor assembly 20 eliminates the need to provide additional movement space for the lens assembly 33. Furthermore, the lens 30 is partially inserted into the accommodating space 111 of the housing 11, thereby reducing an overall structural dimension of the lens module 100. The driving assembly 13, disposed between an outer wall of the lens 30 and an inner wall of the housing 11, effectively utilizes an internal space of the housing 11, thereby avoiding enlargement of a screen opening of the lens 30, so as to effectively increase a screen-to-body ratio. Additionally, compared to conventional lens movement solutions, the sensor assembly 20 in the present disclosure directly moves along a direction of the optical axis 31 of the lens 30, so as to enable precise focus adjustment along the optical axis 31 of the lens 30, achieving a wider field of view (FOV) under identical screen opening dimensions.

Furthermore, the light-transmitting hole 133 on the upper cover 115 of the housing 11 and a central axis of a bottom through hole 114 on a bottom portion of the housing 11 are aligned with the optical axis 31 of the lens 30. The sensor assembly 20 is supported by the elastic support component 12 and arranged along the optical axis 31 of the lens 30, and the sensor assembly 20 is disposed corresponding to the lens 30.

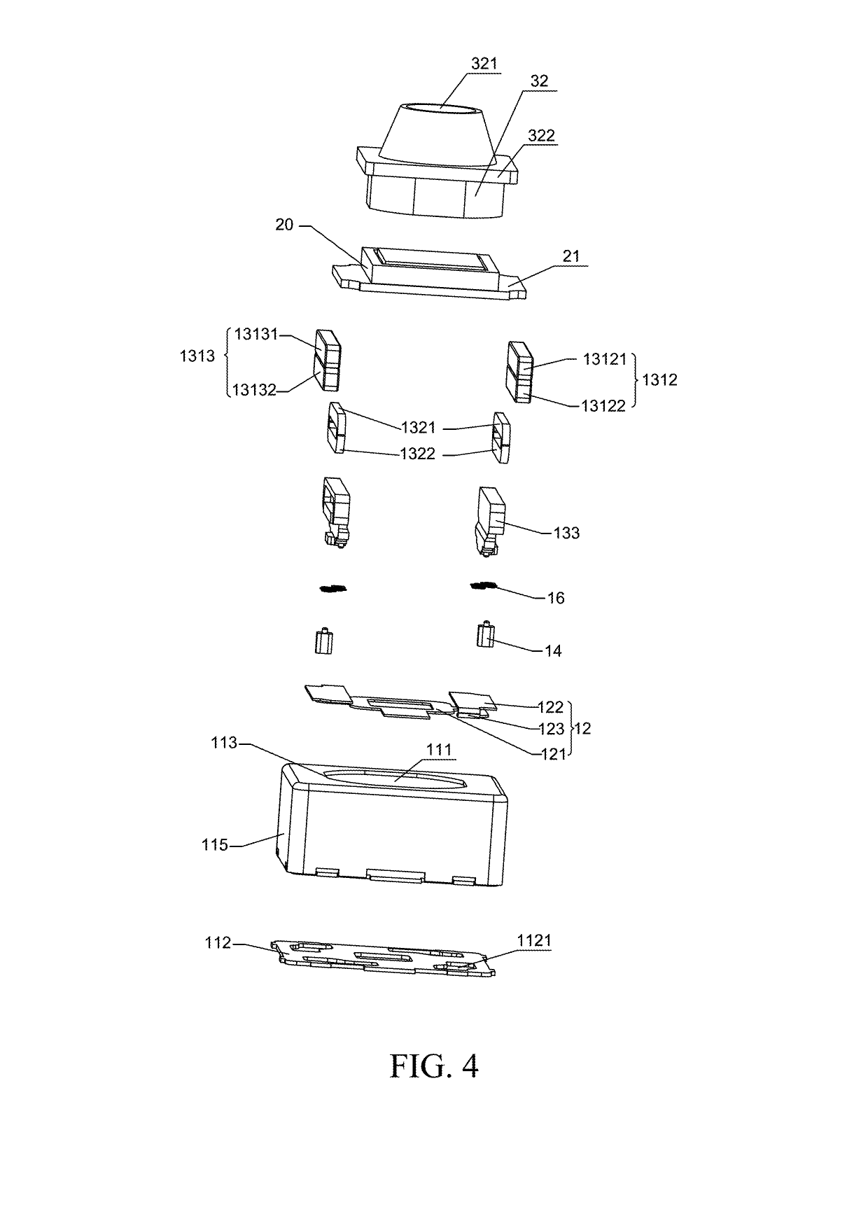

As shown in FIGS. 4-8, in some embodiments, the driving coil 132 includes an upper coil portion 1321 and a lower coil portion 1322, the upper coil portion 1321 is disposed close to the light-transmitting hole 113, and the lower coil portion 1322 is disposed close to the circuit board 21.

In some embodiments, the upper coil portion 1321 and the lower coil portion 1322 are integrally formed.

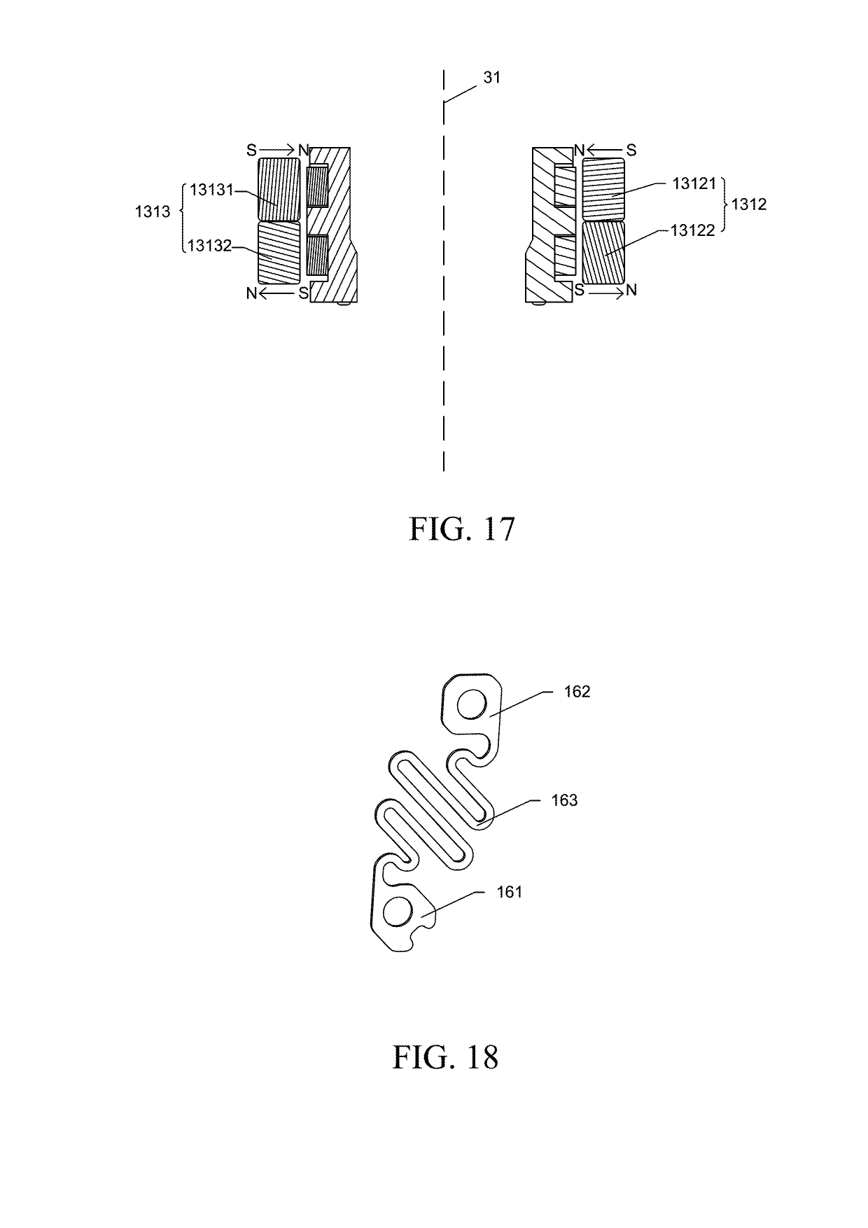

In some embodiments, the magnetic circuit system 131 includes a first magnet assembly 1312 and a second magnet assembly 1313, the first magnet assembly 1312 and the second magnet assembly 1313 are respectively fixed to two opposite side walls of the upper cover 115. The first magnet assembly 1312 includes a first magnet 13121 and a second magnet 13122, the first magnet 13121 and the second magnet 13122 are stacked along a direction parallel to the optical axis 31 of the lens 30, and a magnetization direction of the first magnet 13121 is opposite to a magnetization direction of the second magnet 13122 (referring to FIG. 17). The second magnet assembly 1313 includes a third magnet 13131 and a fourth magnet 13132, the third magnet 13131 and the fourth magnet 13132 are stacked along the direction parallel to the optical axis 31 of the lens 30, and a magnetization direction of the third magnet 13131 is opposite to a magnetization direction of the fourth magnet 13132 (referring to FIG. 17). The upper coil portion 1321 is disposed opposite to the first magnet 13121 and the third magnet 13131. The lower coil portion 1322 is disposed opposite to the second magnet 13122 and the fourth magnet 13132.

In one embodiment of the present disclosure, the first magnet 13121, the second magnet 13122, the third magnet 13131, and the fourth magnet 13132 are all strip-shaped and fixed to an inner side wall of the housing 11. Specifically, the magnetization direction of the first magnet 13121 and the magnetization direction of the third magnet 13131 point toward the optical axis 31 of the lens 30, while the magnetization direction of the second magnet 13122 and the magnetization direction of the fourth magnet 13132 point away from the optical axis 31 of the lens 30.

Referring to FIG. 17, in some embodiments, the first magnet 13121 and the second magnet 13122 are integrally formed using a quadrupole magnetization process. Specifically, along the direction of the optical axis 31 of the lens 30, a first end of the first magnet 13121 facing the optical axis 31 of the lens 30 is magnetized as an N pole, while a second end of the first magnet 13121 facing away from the optical axis 31 of the lens 30 is magnetized as an S pole. A first end of the second magnet 13122 facing the optical axis 31 of the lens 30 is magnetized as an S pole, while a second end of the second magnet 13122 facing away from the optical axis 31 of the lens 30 is magnetized as an N pole. Furthermore, the first magnet 13121 and the second magnet 13122 are integrally formed using the quadrupole magnetization process. It should be understood that quadrupole magnetization refers to magnetizing magnets into four alternating magnetic poles (N-S-N-S), forming four distinct magnetic pole regions. Such configuration ensures a uniform magnetic field distribution in multiple directions, thereby reducing magnetic field distortion. Additionally, such multipole magnetic field may better cooperate with the driving coil 132, generating a more concentrated electromagnetic force to improve driving efficiency and response speed. Furthermore, such configuration facilitates precise magnetic field control, which contributes to enhanced accuracy and stability in movement of the sensor assembly 20.

In some embodiments, the third magnet 13131 and the fourth magnet 13132 are integrally formed using the quadrupole magnetization process. Specifically, along the direction of the optical axis 31 of the lens 30, a first end of the third magnet 13131 facing the optical axis 31 of the lens 30 is magnetized as an N pole, while a second end of the third magnet 13131 facing away from the optical axis 31 of the lens 30 is magnetized as an S pole. A first end of the fourth magnet 13132 facing the optical axis 31 of the lens 30 is magnetized as an S pole, while a second end of the fourth magnet 13132 facing away from the optical axis 31 of the lens 30 is magnetized as an N pole. Furthermore, the third magnet 13131 and the fourth magnet 13132 are integrally formed using the quadrupole magnetization process.

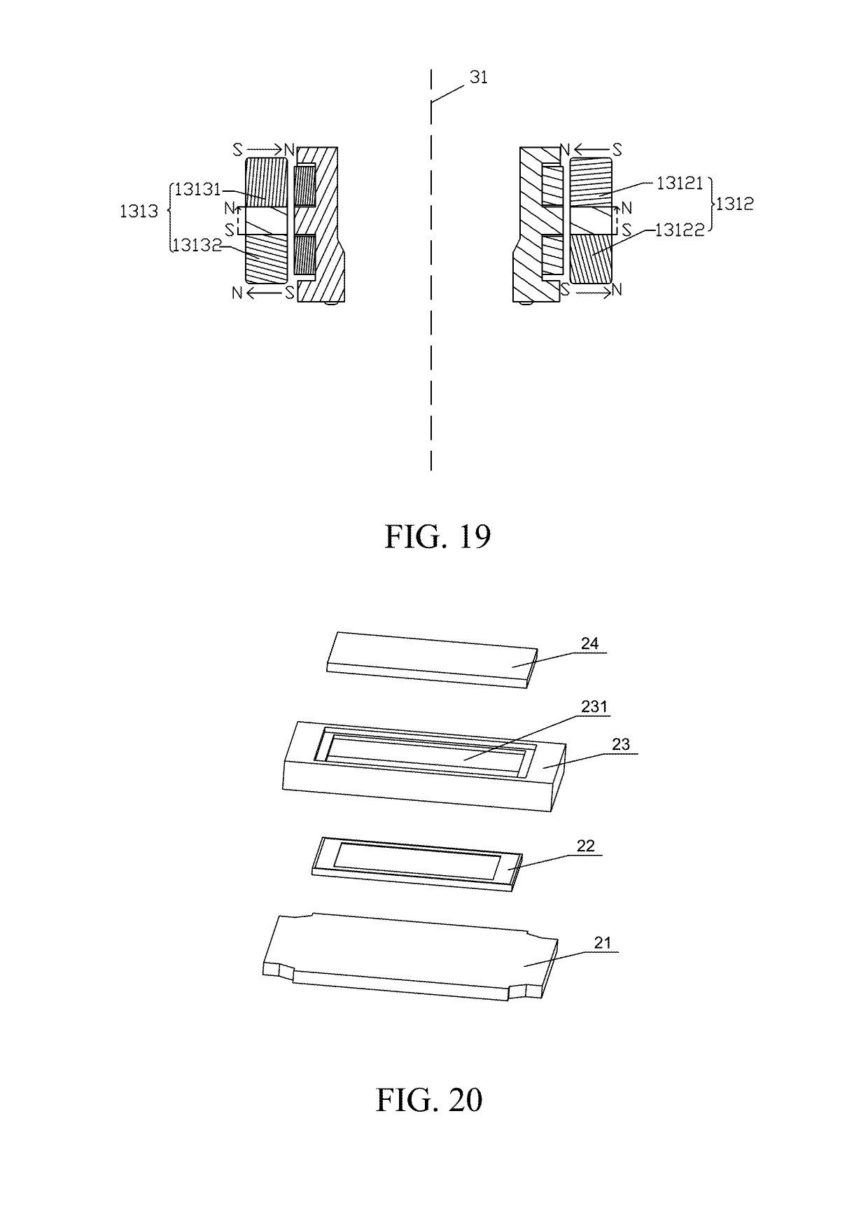

Referring to FIG. 19, in some embodiments, the magnetic circuit system 131 includes the first magnet assembly 1312 and the second magnet assembly 1313, the first magnet assembly 1312 and the second magnet assembly 1313 are respectively fixed to the two opposite side walls of the upper cover 115. Both the first magnet assembly 1312 and the second magnet assembly 1313 are integrally formed using a Halbach array process. It is understood that, magnetization orientations of the first magnet assembly 1312 and the second magnet assembly 1313 are configured according to the quadrupole magnetization process and integrally formed using the Halbach array process. A magnetization orientation between the first magnet 13121 and the second magnet 13122, as well as a magnetization orientation between the third magnet 13131 and the fourth magnet 13132, follows configurations shown in FIG. 19. Specifically, in the Halbach array process, magnetization directions of adjacent magnets rotate in a specific pattern, resulting in enhanced magnetic field strength on one side and near-zero magnetic field on the opposite side. Through such arrangement and magnetization direction of magnets, the Halbach array process generates a highly concentrated and uniform magnetic field in a specific region while minimizing or eliminating unwanted magnetic fields in other regions.

In the present disclosure, the first magnet assembly 1312 and the second magnet assembly 1313 are formed using the Halbach array process, so as to generate a strong and uniform magnetic field on one side while maintaining negligible magnetic field on the other side. Such characteristic is particularly suitable for applications requiring unidirectional strong magnetic fields. By adjusting a number and arrangement of magnets, magnetic field distributions with different pole configurations (e.g., quadpole, hexapole) are achieved to meet diverse application requirements. Compared to conventional magnet arrangements, Halbach array more efficiently utilizes magnetic materials, minimizes magnetic losses, and enhances magnetic field utilization efficiency.

In a first specific embodiment of the present disclosure, the first magnet 13121 and the second magnet 13122 are configured in a split configuration, and the first magnet 13121 and the second magnet 13122 are individually fabricated and then assembled to form the first magnet assembly 1312. The third magnet 13131 and the fourth magnet 13132 are also configured in the split configuration, and the third magnet 13131 and the fourth magnet 13132 are individually fabricated and then assembled to form the second magnet assembly 1313.

In a second specific embodiment of the present disclosure, the first magnet assembly 1312 and the second magnet assembly 1313 are respectively integrally formed using the quadrupole magnetization process, and the first magnet assembly 1312 and the second magnet assembly 1313 are assembled to form the magnetic circuit system 131.

In a third specific embodiment of the present disclosure, the first magnet assembly 1312 and the second magnet assembly 1313 are respectively integrally formed using the Halbach array process, and the first magnet assembly 1312 and the second magnet assembly 1313 are assembled to form the magnetic circuit system 131.

In some embodiments, specifically referring to FIG. 8, the at least one coil holder 133 includes an annular mounting groove 1331 at one side thereof facing the magnetic circuit system 131, and the driving coil 132 is annularly disposed in the annular mounting groove 1331. Specifically, the drive coil 132 is annular in shape and complementary in shape to the annular mounting groove 1331. The annular mounting groove 1331 internally includes a positioning protrusion 1332. The driving coil 132 is sleeved on the positioning protrusion 1332 and annularly disposed in the annular mounting groove 1331.

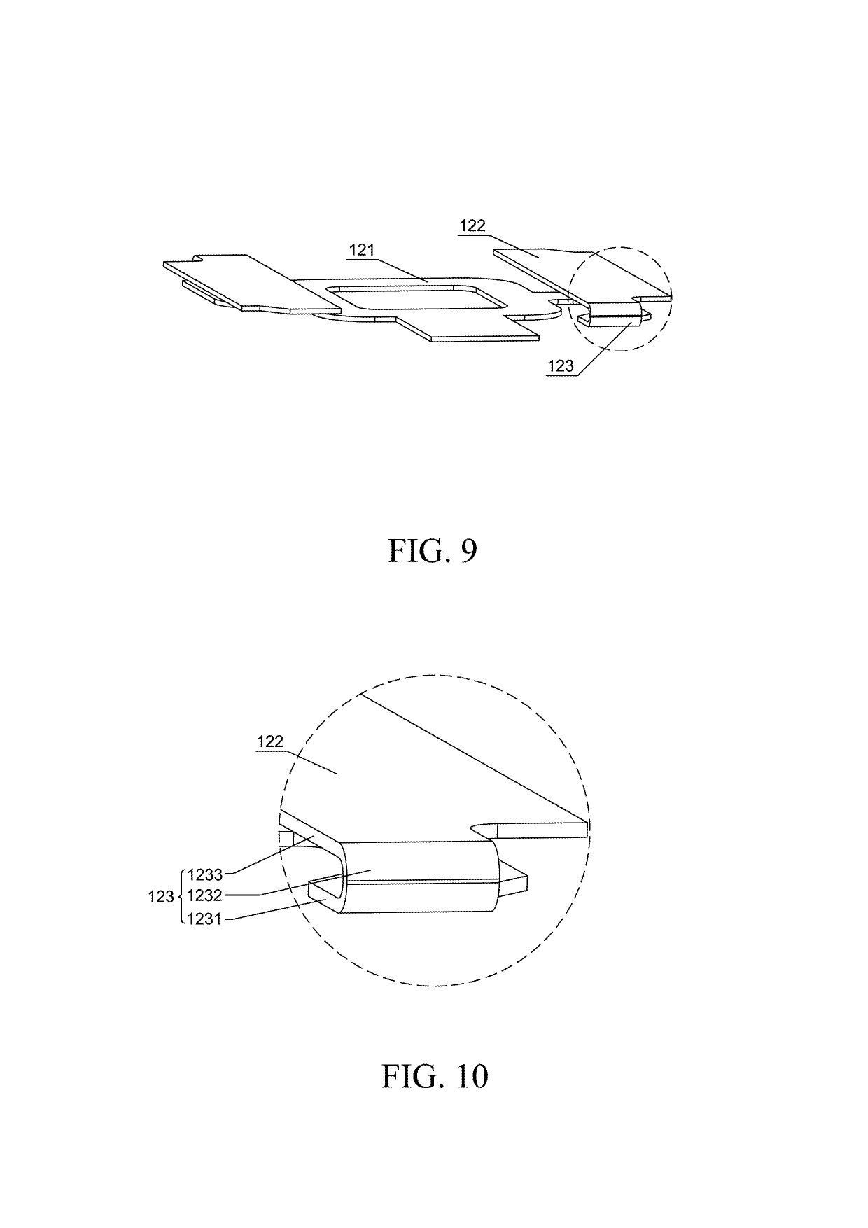

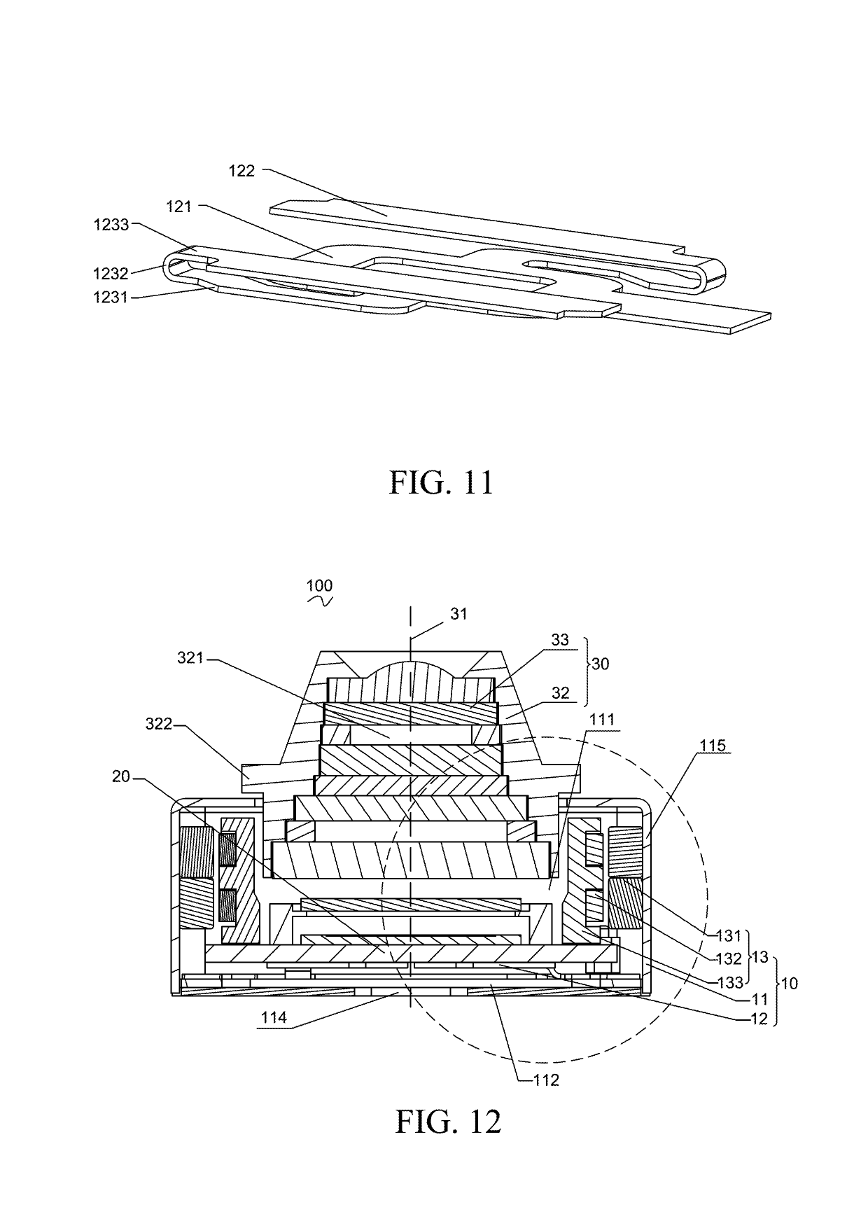

Referring to FIGS. 9-11, in one embodiment, the first connecting portion 121 and the at least one second connecting portion 122 are both plate-shaped.

In some embodiments, the at least one elastic arm 123 includes a first force arm 1231, a second force arm 1232, and a third force arm 1233. The first force arm 1231 is connected to the first connecting portion 121, the second force arm 1232 is bent and extend from the first force arm 1231, the third force arm 1233 extends from one end of the second force arm 1232 away from the first force arm 1231, and the third force arm 1233 is connected to the at least one second connecting portion 122. The first force arm 1231 is disposed opposite to the third force arm 1233.

In some embodiments, the first force arm 1231 and the third force arm 1233 are parallel to each other.

Referring to FIGS. 14 and 16, in some embodiments, the elastic support component 12 includes a plurality of elastic arms 123, the plurality of the elastic arms 123 are rotationally symmetric about a center of the elastic support component 12.

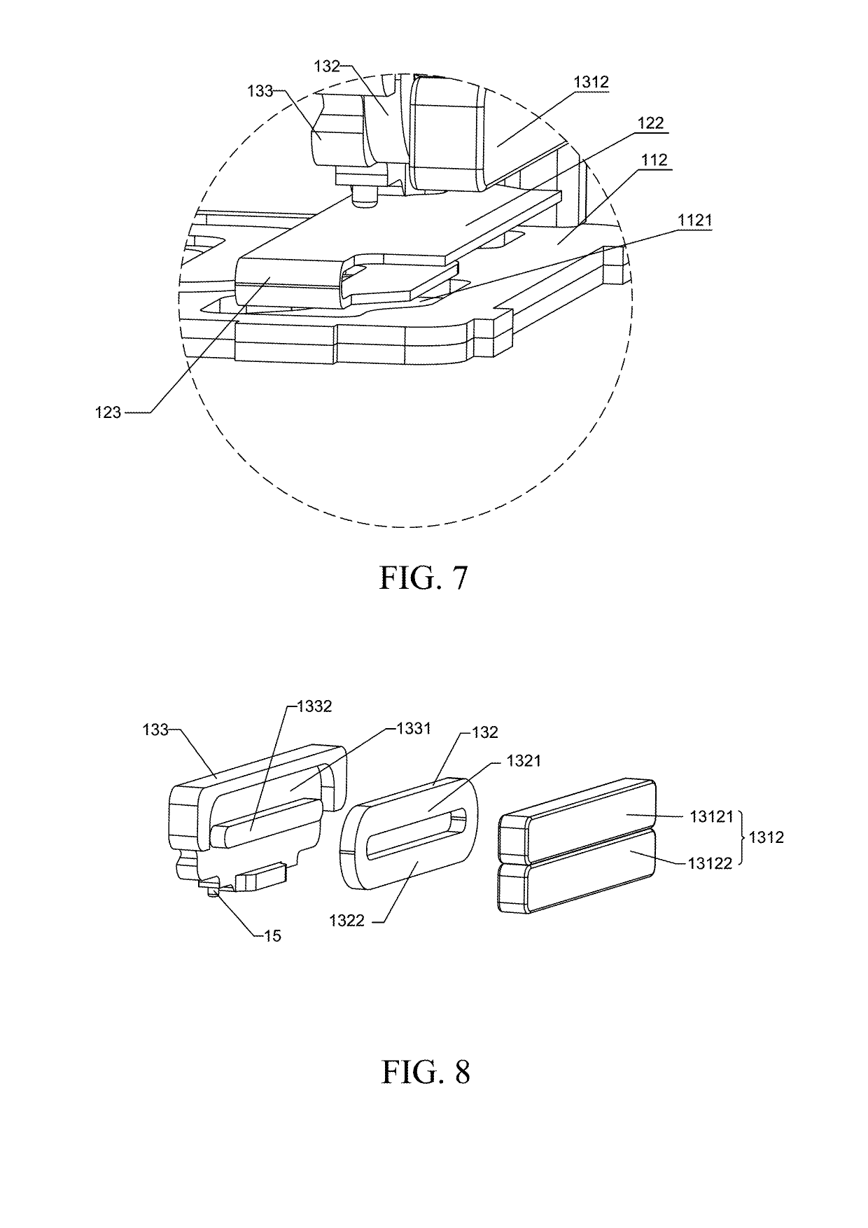

In one embodiment of the present disclosure, further referring to FIGS. 9-11, the first connecting portion 121 is frame-shaped. The at least one elastic arm 123 and the at least one second connecting portion 122 are disposed an outer peripheral side of the first connecting portion 121, and the at least one elastic arm 123 is connected to an outer frame edge of the first connecting portion 121. Furthermore, the bottom plate 112 includes at least one clearance portion 1121 (referring to FIG. 7), the at least one clearance portion 1121 is configured to provide clearance for the at least one elastic arm 123. Specifically, the at least one clearance portion 1121 is recessed from a surface of the bottom plate 112 facing the circuit board 21, the at least one clearance portion 1121 is positioned corresponding to the at least one elastic arm 123. Along the optical axis 31 of the lens 30, the at least one elastic arm 123 has a defined movement range within the at least one clearance portion 1121.

In some embodiments, two second connecting portions 122 are provided and spaced apart from each other, each of the two second connecting portions 122 is fixedly connected to the circuit board 21, two elastic arms 123 are provided, the two second connecting portions 122 are respectively connected to the two elastic arms 123, and third force arms 1233 of the two elastic arms 123 extend in opposite directions.

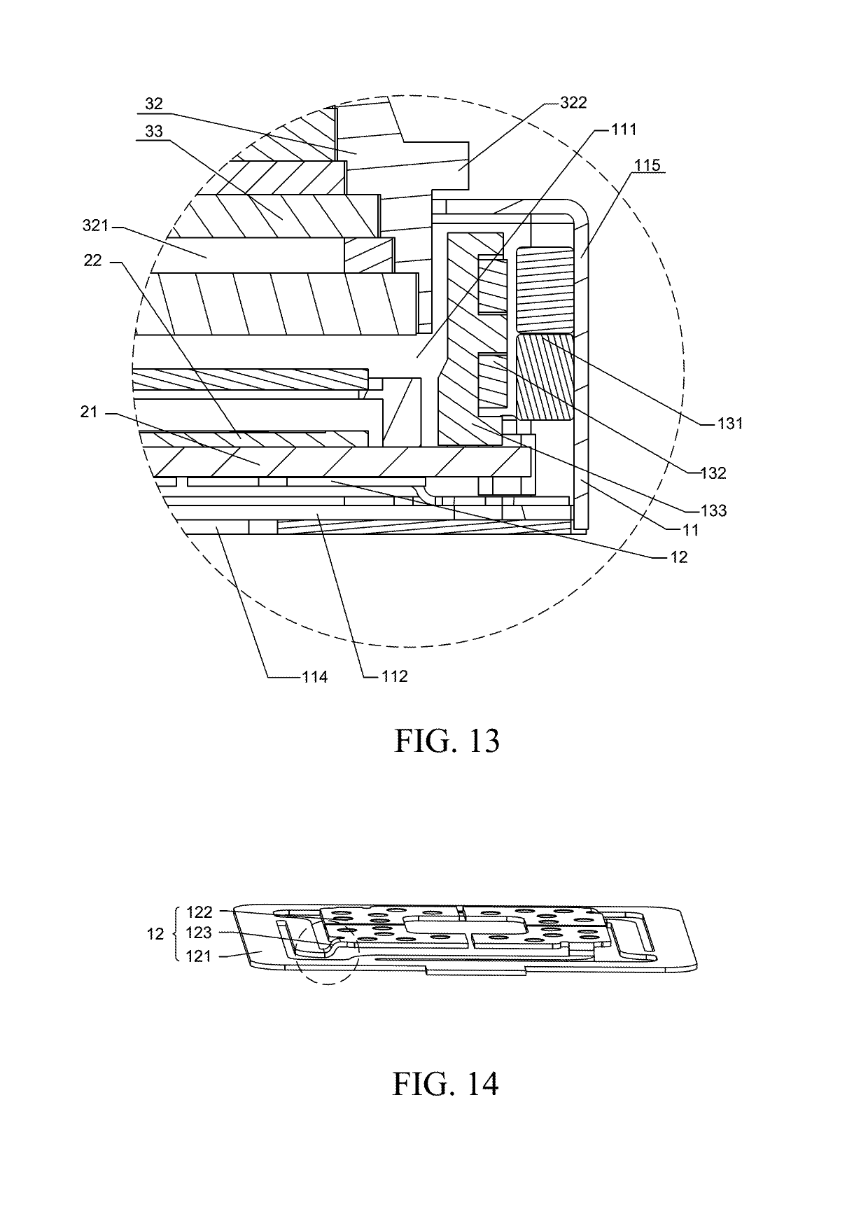

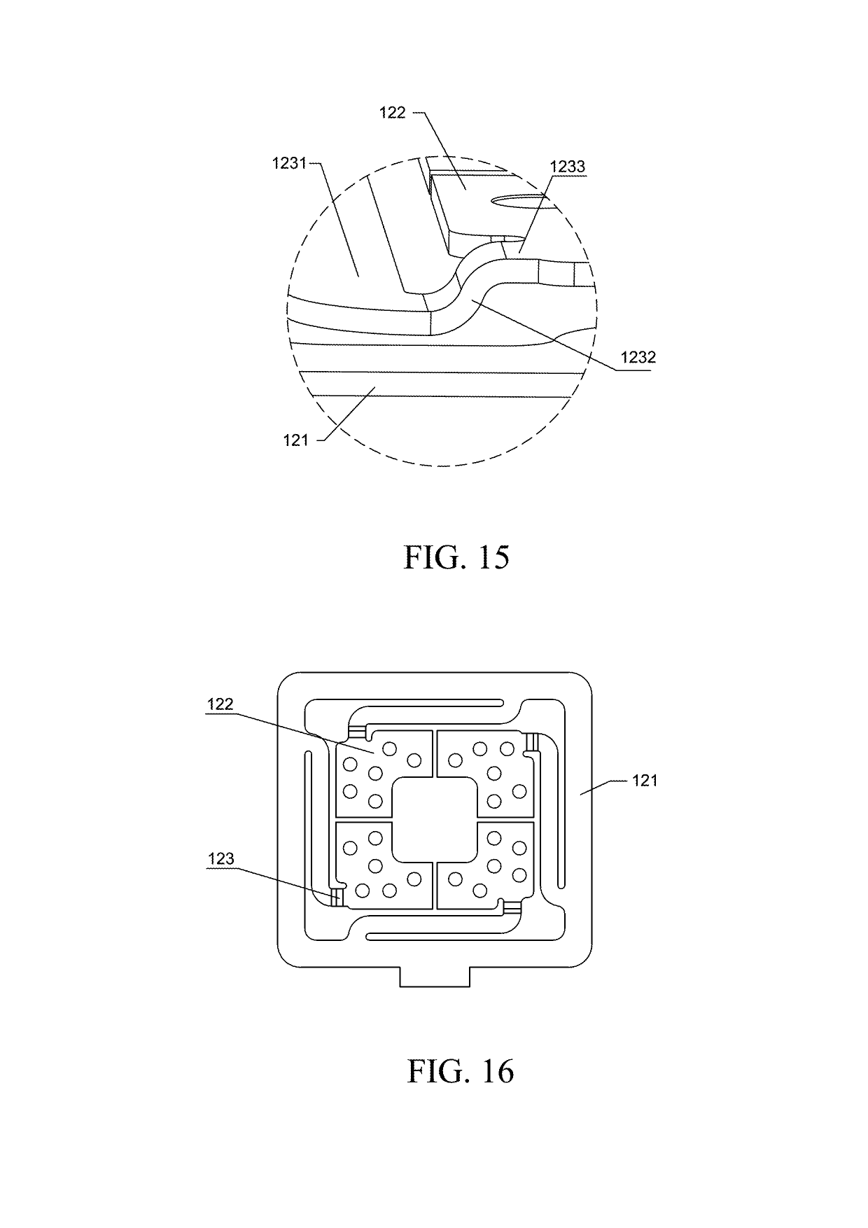

In some other embodiments, referring to FIGS. 12-16, the first connecting portion 121 is frame-shaped. The at least one elastic arm 123 and the at least one second connecting portion 122 are disposed on an inner peripheral side of the first connecting portion 121, and the at least one elastic arm 123 is connected to an inner frame edge of the first connecting portion 121.

In some embodiments, four second connecting portions 122 are provided, and the four second connecting portions 122 are circumferentially spaced along the inner peripheral side of the first connecting portion 121. Each of the four second connecting portions 122 is fixedly connected to the circuit board 21, four elastic arms 123 are provided, and the four second connecting portions 122 are respectively connected to the four elastic arms 123. Specifically, the four elastic arms 123 are rotationally symmetric about a center of the first connecting portion 121.

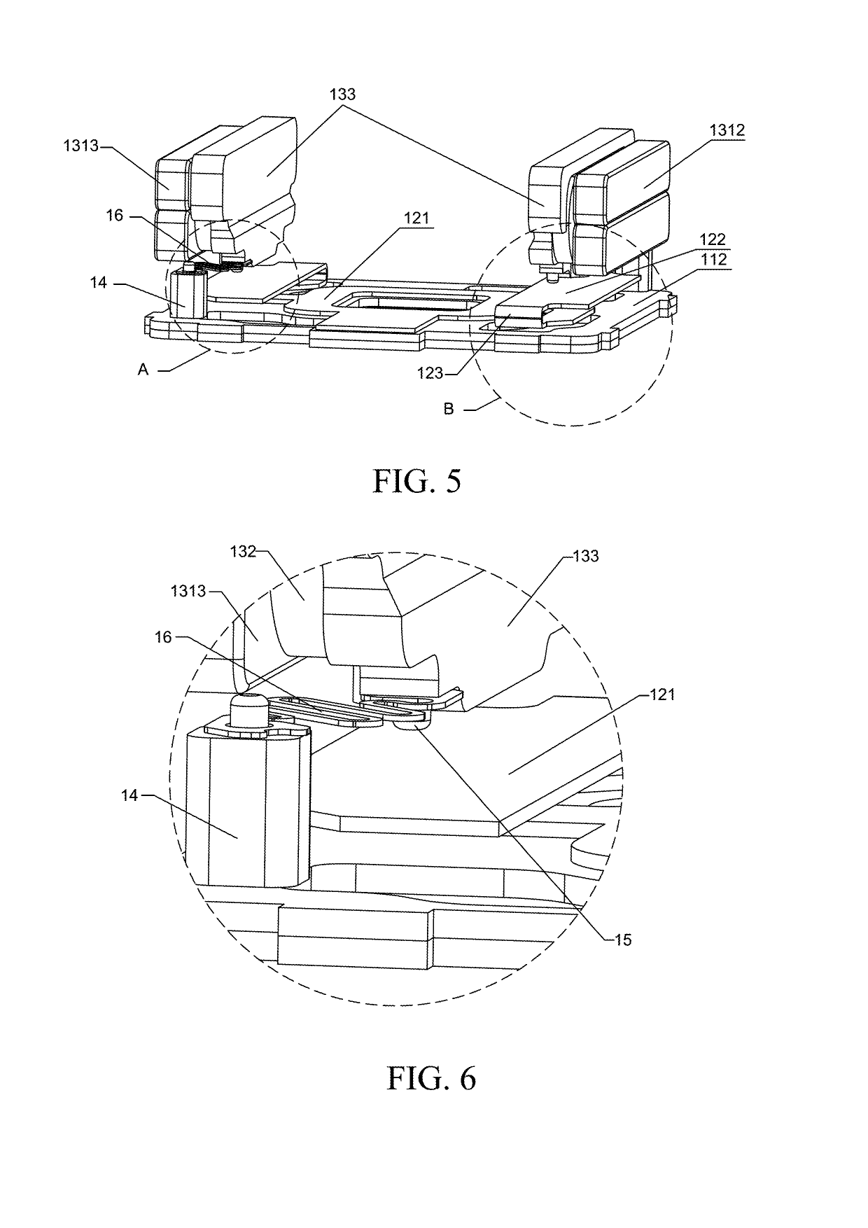

In some embodiments, specifically referring to FIGS. 5-6, at least one connecting post 14 is disposed on the bottom plate 112, and a connecting protrusion 15 extends from the at least one coil holder 133 toward the circuit board 21. The at least one connecting post 14 and the connecting protrusion 15 of the at least one coil holder 133 are connected through an elastic component 16.

In some embodiments, further referring to FIGS. 5-6, the bottom plate 112 is rectangular in shape. Two connecting posts 14 are provided and are diagonally disposed, a first end of each of the two connecting posts 14 is fixedly connected to the surface of the bottom plate 112 facing the circuit board 21, and a second end of each of the two connecting posts 14 is connected to a corresponding elastic component 16.

In some other embodiments, the bottom plate 112 is rectangular in shape. The two connecting posts 14 are provided and are diagonally disposed, the first end of each of the two connecting posts 14 is fixedly connected to a surface of the first connecting portion 121 facing the circuit board 21, and a second end of each of the two connecting posts 14 is connected to the corresponding elastic component 16.

As shown in FIG. 18, in some embodiments, each elastic component 16 includes a first connecting component 161, a second connecting component 162, and a bent elastic component 163. The first connecting component 161 is fixedly connected to the at least one connecting post 14, the second connecting component 162 is fixedly connected to the connecting protrusion 15, and the bent elastic component 163 is configured to connect the first connecting component 161 and the second connecting component 162.

In the present disclosure, diagonal arrangement of the two connecting posts 14 combined with the corresponding elastic component 16 ensures enhanced structural stability under external forces, effectively suppressing vibrations. Additionally, the bent elastic component 163 of each elastic component 16 acts as a buffer during impacts or vibrations, reducing force transmission to other components and further aiding vibration suppression.

In one specific embodiment of the present disclosure, the at least one elastic arm 123 is U-shaped, and the drive coil 132 is directly electrically connected to the circuit board 21. It is understood that a shape of the at least one elastic arm 123 is not limited to U-shaped and may include other configurations.

In some other embodiments, the drive coil 132 is electrically connected to the circuit board 21 through the elastic component 16. The drive coil 132, disposed in the at least one coil holder 133, generates a magnetic field based on current flow, which interacts with a magnetic field of the magnetic circuit system 131 to drive the sensor assembly 20 to move along the optical axis 31 of the lens 30.

In another one specific embodiment of the present disclosure, the second force arm 1232 is Z-shaped.

In some embodiments, a flexible circuit board is printed on the elastic component 16, enabling the elastic component 16 to conduct electrical current from the sensor assembly 20 to the driving coil 132.

Referring to FIGS. 1-3, 12-13, and 20, in a second aspect of the embodiments of the present disclosure, a lens module 100 is provided, including the sensor driving device 10 as foregoing, the sensor assembly 20, and the lens. The sensor assembly 20 is disposed in the housing 11 and connected to the elastic support component 12. The lens 30 is inserted into the light-transmitting hole 113 on the upper cover 115 of the housing 11 to suspend in the accommodating space 111.

In some embodiments, the lens 30 includes a lens barrel 32 and a lens assembly 33. The lens barrel 32 includes an accommodating portion 321 and a suspension structure 322, and the accommodating portion 321 is configured to accommodate the lens assembly 33. The lens barrel 32 is inserted into the light-transmitting hole 113 on the upper cover 115 of the housing 11 through the suspension structure 322.

In one specific embodiment of the present disclosure, the suspension structure 322 is annular and annularly disposed around a peripheral side of the lens barrel 32. The suspension structure 322 is configured to abut against a top wall of the housing 11, so as to suspend the lens 30 in the accommodating space 111 of the housing 11.

Specifically, the sensor driving device 10 includes the housing 11, the sensor assembly 20 is disposed in the housing 11 and connected to the elastic support component 12. The lens 30 is inserted into the light-transmitting hole 113 on the upper cover 115 of the housing 11 to suspend in the accommodating space 111, and the lens 30 is disposed corresponding to the sensor assembly 20. The lens 30 is disposed at the light-transmitting hole 113, and along the optical axis 31 of the lens 30, the lens 30 and the sensor assembly 20 are sequentially arranged. The sensor driving device 10 is disposed around the lens 30, configured to drive the sensor assembly 20 to move along the optical axis 31 of the lens 30.

More specifically, the electrical current generated by the sensor assembly 20 is conducted to the driving coil 132 of the sensor driving device 10 through the elastic component 16, or directly conducted to the driving coil 132 through the circuit board 21. When current flows through the driving coil 132, interaction between the magnetic field of the driving coil 132 and the magnetic field of the magnetic circuit system 131 generates a force acting on the sensor assembly 20, causing the sensor assembly 20 to move along the optical axis 31 of the lens 30, thereby achieving focus adjustment.

In the fixed-focus OIS design of the present disclosure, the movement of the sensor assembly 20 eliminates the need to provide additional movement space for the lens assembly 33. Furthermore, the lens 30 is partially inserted into the accommodating space 111 of the housing 11, thereby reducing the overall structural dimension of the lens module 100. The driving assembly 13, disposed between the outer wall of the lens 30 and the inner wall of the housing 11, effectively utilizes the internal space of the housing 11, thereby avoiding the enlargement of the screen opening of the lens 30, so as to effectively increase the screen-to-body ratio. Additionally, compared to the conventional lens movement solutions, the sensor assembly 20 in the present disclosure directly moves along the direction of the optical axis 31 of the lens 30, so as to enable the precise focus adjustment along the optical axis 31 of the lens 30, achieving the wider FOV under the identical screen opening dimensions.

Further referring to FIG. 20 the sensor assembly 20 includes the circuit board 21, the sensor 22, a sensor holder 23, and a filter 24, the circuit board 21, the sensor 22, the sensor holder 23, and the filter 24 are stacked in sequence. The sensor holder 23 is configured to cover the sensor 22 on the circuit board 21. The sensor holder 23 includes a mounting cavity 231 complementary in shape to the filter 24, and the filter 24 is disposed in the mounting cavity 231.

In a third aspect, the embodiments of the present disclosure provides augmented reality (AR) glasses, the AR glasses include the lens module 100 as foregoing.

It should be understood that the embodiments are merely exemplary implementations intended to illustrate principles of the present disclosure. However, the present disclosure is not limited thereto. For those who skilled in the art, various modifications and improvements may be made without departing from spirit and essence of the present disclosure, and such modifications and improvements shall also fall within a projection scope of the present disclosure.

What is claimed is:

1. A sensor driving device, comprising:
a housing;
a sensor assembly;
a driving assembly; and
an elastic support component;
wherein the housing comprises a bottom plate and an upper cover, the upper cover covers the bottom plate to define an accommodating space therebetween, the upper cover comprises a light-transmitting hole, the light-transmitting hole communicates the accommodating space and an external environment and is configured to communicate with a lens;
wherein the sensor assembly is disposed in the accommodating space, the sensor assembly comprises a circuit board and a sensor, the sensor is disposed at one side of the circuit board close to the light-transmitting hole and is electrically connected to the circuit board;
wherein the driving assembly is disposed in the accommodating space, the driving assembly comprises at least one coil holder, a magnetic circuit system, and a driving coil, the at least one coil holder is fixed to the one side of the circuit board close to the light-transmitting hole, the magnetic circuit system is fixed to an inner side of the upper cover, and the driving coil is fixed to an outer side of the at least one coil holder;
wherein the elastic support component is disposed in the accommodating space, the elastic support component is connected between the circuit board and the bottom plate, the elastic support component comprises a first connecting portion, at least one second connecting portion, and at least one elastic arm, the first connecting portion is fixed to the bottom plate, the at least one second connecting portion is fixed to the circuit board, and the at least one elastic arm is configured to connect the first connecting portion and the at least one second connecting portion, the elastic support component is configured to suspend the sensor assembly in the accommodating space;
wherein the driving coil is disposed opposite to the magnetic circuit system, the driving coil and the magnetic circuit system cooperate to drive the sensor assembly to move along an optical axis of the lens.

2. The sensor driving device according to claim 1, wherein the driving coil comprises an upper coil portion and a lower coil portion, the upper coil portion is disposed close to the light-transmitting hole, and the lower coil portion is disposed close to the circuit board.

3. The sensor driving device according to claim 2, wherein the magnetic circuit system comprises a first magnet assembly and a second magnet assembly, the first magnet assembly and the second magnet assembly are respectively fixed to two opposite side walls of the upper cover;
the first magnet assembly comprises a first magnet and a second magnet, the first magnet and the second magnet are stacked along a direction parallel to the optical axis of the lens, and a magnetization direction of the first magnet is opposite to a magnetization direction of the second magnet;
the second magnet assembly comprises a third magnet and a fourth magnet, the third magnet and the fourth magnet are stacked along the direction parallel to the optical axis of the lens, and a magnetization direction of the third magnet is opposite to a magnetization direction of the fourth magnet;
the upper coil portion is disposed opposite to the first magnet and the third magnet; and
the lower coil portion is disposed opposite to the second magnet and the fourth magnet.

4. The sensor driving device according to claim 3, wherein the first magnet and the second magnet are integrally formed using a quadrupole magnetization process; and
the third magnet and the fourth magnet are integrally formed using the quadrupole magnetization process.

5. The sensor driving device according to claim 2, wherein the magnetic circuit system comprises a first magnet assembly and a second magnet assembly, the first magnet assembly and the second magnet assembly are respectively fixed to two opposite side walls of the upper cover; and
both the first magnet assembly and the second magnet assembly are integrally formed using a Halbach array process.

6. The sensor driving device according to claim 2, wherein the at least one coil holder comprises an annular mounting groove at one side thereof facing the magnetic circuit system, and the driving coil is annularly disposed in the annular mounting groove.

7. The sensor driving device according to claim 1, wherein the at least one elastic arm comprises a first force arm, a second force arm, and a third force arm;
the first force arm is connected to the first connecting portion, the second force arm is bent and extend from the first force arm, the third force arm extends from one end of the second force arm away from the first force arm, and the third force arm is connected to the at least one second connecting portion; and
the first force arm is disposed opposite to the third force arm.

8. The sensor driving device according to claim 1, wherein the elastic support component comprises a plurality of elastic arms, the plurality of the elastic arms are rotationally symmetric about a center of the elastic support component.

9. The sensor driving device according to claim 7, wherein the first connecting portion is frame-shaped;
the at least one elastic arm and the at least one second connecting portion are disposed an outer peripheral side of the first connecting portion, and the at least one elastic arm is connected to an outer frame edge of the first connecting portion.

10. The sensor driving device according to claim 9, wherein the bottom plate comprises at least one clearance portion, the at least one clearance portion is configured to provide clearance for the at least one elastic arm.

11. The sensor driving device according to claim 9, wherein two second connecting portions are provided and spaced apart from each other, each of the two second connecting portions is fixedly connected to the circuit board, two elastic arms are provided, the two second connecting portions are respectively connected to the two elastic arms, and third force arms of the two elastic arms extend in opposite directions.

12. The sensor driving device according to claim 8, wherein the first connecting portion is frame-shaped;
the at least one elastic arm and the at least one second connecting portion are disposed on an inner peripheral side of the first connecting portion, and the at least one elastic arm is connected to an inner frame edge of the first connecting portion.

13. The sensor driving device according to claim 12, wherein four second connecting portions are provided, and the four second connecting portions are circumferentially spaced along the inner peripheral side of the first connecting portion; and
each of the four second connecting portions is fixedly connected to the circuit board, four elastic arms are provided, and the four second connecting portions are respectively connected to the four elastic arms.

14. The sensor driving device according to claim 1, wherein at least one connecting post is disposed on the bottom plate, and a connecting protrusion extends from the at least one coil holder toward the circuit board; and
the at least one connecting post and the connecting protrusion of the at least one coil holder are connected through an elastic component.

15. A lens module, comprising:
the sensor driving device according to claim 1;
the sensor assembly; and
the lens;
wherein the sensor assembly is disposed in the housing and connected to the elastic support component;
wherein the lens is inserted into the light-transmitting hole on the upper cover of the housing to suspend in the accommodating space.

16. The lens module according to claim 15, wherein the lens comprises a lens barrel and a lens assembly;
the lens barrel comprises an accommodating portion and a suspension structure, and the accommodating portion is configured to accommodate the lens assembly; and
the lens barrel is inserted into the light-transmitting hole on the upper cover of the housing through the suspension structure.

17. The lens module according to claim 15, wherein the driving coil comprises an upper coil portion and a lower coil portion, the upper coil portion is disposed close to the light-transmitting hole, and the lower coil portion is disposed close to the circuit board.

18. The lens module according to claim 17, wherein the magnetic circuit system comprises a first magnet assembly and a second magnet assembly, the first magnet assembly and the second magnet assembly are respectively fixed to two opposite side walls of the upper cover;
the first magnet assembly comprises a first magnet and a second magnet, the first magnet and the second magnet are stacked along a direction parallel to the optical axis of the lens, and a magnetization direction of the first magnet is opposite to a magnetization direction of the second magnet;
the second magnet assembly comprises a third magnet and a fourth magnet, the third magnet and the fourth magnet are stacked along the direction parallel to the optical axis of the lens, and a magnetization direction of the third magnet is opposite to a magnetization direction of the fourth magnet;
the upper coil portion is disposed opposite to the first magnet and the third magnet; and
the lower coil portion is disposed opposite to the second magnet and the fourth magnet.

19. The lens module according to claim 18, wherein the first magnet and the second magnet are integrally formed using a quadrupole magnetization process; and
the third magnet and the fourth magnet are integrally formed using the quadrupole magnetization process.

20. The lens module according to claim 17, wherein the magnetic circuit system comprises a first magnet assembly and a second magnet assembly, the first magnet assembly and the second magnet assembly are respectively fixed to two opposite side walls of the upper cove; and
both the first magnet assembly and the second magnet assembly are integrally formed using a Halbach array process.
